(19) United States
(12) Patent Application Publication
(10) Pub. No.: US 2024/0106015 A1
(43) Pub. Date: Mar. 28, 2024

(54) POWER SUPPLY SYSTEM AND METHOD FOR CHARGING A POWER SUPPLY SYSTEM

(71) Applicant: instagrid GmbH, Ludwigsburg (DE)

(72) Inventors: Sebastian BERNING, Stuttgart (DE); Jakob GANTENBEIN, Ludwigsburg (DE)

(21) Appl. No.: 18/289,684

(22) PCT Filed: Apr. 27, 2022
(86) PCT No.: PCT/EP2022/061163

§ 371 Date: Nov. 6, 2023

(30) Foreign Application Priority Data
May 6, 2021 (DE) 10 2021 111 864.6

(51) Int. Cl. H01M 10/48; H01M 10/44

(52) U.S. Cl. CPC H01M 10/482; H01M 10/44; H01M 2010/4271

(57) ABSTRACT

A power supply system having a multiplicity of battery modules, wherein each battery module has a first electrical terminal and a second electrical terminal, by way of which the battery modules are arranged in series in a circuit branch of the power supply system, and wherein each battery module furthermore has an accumulator, connected to the first and second electrical terminals by way of a bridge circuit of the battery module, wherein the power supply system has a switch arranged in series with the battery modules and temporarily moved into a blocking state, so that, during a charging operation of the power supply system with an AC voltage by an external energy source, a load voltage in the circuit branch does not exceed a maximum permissible charging voltage. In accordance with a further aspect, a method for charging a power supply system with an AC voltage is proposed.

### CROSS-REFERENCE TO RELATED APPLICATIONS

This application is a 35 U.S.C. § 371 National Stage patent application of PCT/EP2022/061163, filed on 27 Apr. 2022, which claims the benefit of German patent application 10 2021 111 864.6, filed on 6 May 2021, the disclosures of which are incorporated herein by reference in their entirety.

### TECHNICAL FIELD

The disclosure relates to a power supply system, and a method for charging a power supply system.

### BACKGROUND

For the mobile supply of energy to powerful machines and vehicles, especially those with an output power rating of more than 1 kW, internal combustion engines are predominantly used at the present time. In order to reduce environmental and health pollution caused by exhaust gases and noise, such energy supply systems are increasingly being replaced by those based on battery storage.

For many applications, it is advantageous if such a power supply system can provide an AC voltage. For example, loads can be cited that are suitable for operation on a standard AC mains voltage, or electric motors such as 3-phase asynchronous machines. Furthermore, for powerful loads it is desirable to provide a supply voltage that is as high as possible in order to keep the required operating currents and thus also the electrical losses low.

To generate such an AC voltage from the DC voltage of a battery storage unit, an electrical converter is required. Today, so-called two- or three-point inverters are used almost exclusively; these generate a 1- or 3-phase, sinusoidal output voltage from an intermediate circuit voltage (battery voltage) by means of chopping and smoothing.

The publication U.S. Pat. No. 3,867,643 A describes an alternative electrical converter in which a multi-stage conversion takes place. Here, a multiplicity of direct current sources, for example batteries, are in each case periodically either connected in series in the current path, or bridged by a bridge circuit, so that a resulting output voltage assumes an approximately sinusoidal curve. The publication U.S. Pat. No. 5,642,275 A executes the implementation of this converter technology with battery modules, wherein each battery module has at least one direct current source and a bridge circuit. Such converters are often referred to in the literature as “cascaded multilevel inverter/converters” or “modular multilevel inverter/converters”. Converters of this type have proven to be advantageous compared to two- or three-point converters, especially with regard to costs, thermal losses, and size.

### SUMMARY

A maximum charging voltage that can be obtained from a power supply system with an appropriate structure depends, among other features, on the number. as well as the dimensions, of the battery modules. An overvoltage can lead to damage of the battery modules. the disclosure therefore provides a power supply system with a cascaded multilevel inverter/converter that can be charged from a supply network that provides an AC current with a peak voltage that is too high for battery modules of the power supply system. The disclosure further relates to providing a method for charging a power system with a cascaded multilevel inverter/converter that allows the power system to be charged on a supply network that provides an AC current with a peak voltage that is too high for battery modules of the power system.

The advantages are achieved by specifying the energy supply system in accordance with claim 1 and the method for charging an energy supply system in accordance with claim 22. The subsidiary claims relate to various mutually independent, advantageous further developments of the present disclosure, the features of which can be freely combined with one another by the person skilled in the art within the scope of what is technically sensible, in particular also across the different categories of claims.

A first aspect of the disclosure relates to a power supply system comprising a multiplicity of battery modules, wherein each battery module has a first electrical terminal and a second electrical terminal, by way of which the battery modules are arranged in series in a circuit branch of the power supply system, wherein each battery module further comprises an accumulator, which can be connected to the first electrical terminal and the second electrical terminal by way of a bridge circuit of the battery module, wherein the power supply system has a switch, which is arranged in series with the battery modules, and can temporarily be moved into a blocking state, so that, during a charging operation of the power supply system with an AC voltage by an external power source, a load voltage in the circuit branch does not exceed a maximum permissible charging voltage.

If the voltage applied to the power supply system exceeds the maximum permissible charging voltage, the switch is moved into the blocking state. This prevents the battery modules from being subjected to a voltage for which they may not be designed. The bridge circuit can basically be a bridge circuit of any type. With the aid of the bridge circuit, it is preferably possible to connect the accumulator to the circuit branch in different ways. Thus, in accordance with the disclosure, it is conceivable to connect the battery module with different polarities, or for the battery module to be bridged by means of the bridge circuit. By a suitable control of the bridge circuits, the power supply system can provide an AC voltage. In accordance with a variant of the disclosure, the maximum permissible charging voltage can be a predefined fixed voltage value, but it is alternatively possible that it is a variable value that is continuously adjusted during operation of the power supply system. For example, the maximum permissible charging voltage may be dependent on charging states of the accumulators in the battery modules. In accordance with the disclosure, the battery modules may have voltage measuring devices for this purpose that can monitor the charging states of the accumulators. The power supply system is preferably quite compactly dimensioned. Thus, it is preferably a portable/mobile energy supply system that can be used in a variety of ways, for example, on construction sites to provide electrical energy.

In accordance with the disclosure, it is possible for the power supply system to have a control unit, which is set up to move the switch into the blocking state as soon as the load voltage exceeds the maximum permissible charging voltage. The control unit can be coupled with at least one voltage measuring device, with at least one current measuring device and/or further sensors. On the basis of a measured voltage, and optionally on the basis of further values, the control unit can decide whether the switch is to be moved into the blocking state. In accordance with the disclosure, the control unit can also be used to control the bridge circuits of the battery modules, and/or other components of the power supply system.

It is advantageous if the control unit is set up to move the switch from the blocking state into a non-blocking state during the charging process as soon as the circuit branch is subjected to a voltage that is so high that the load voltage, after moving the switch into the non-blocking state, is lower than the maximum permissible charging voltage of the power supply system. In accordance with the disclosure, the power supply system can be charged with an AC voltage. A provided voltage will generally rise and fall sinusoidally. The voltage provided will generally continue to rise after exceeding the maximum charging voltage, then reach a peak and drop again. At a certain point in time, the voltage is again so low that after moving the switch into the non-blocking state, a load voltage would be present at the battery modules that is lower than the maximum permissible charging voltage of the power supply system. At this point, the switch is returned to the non-blocking state so that the battery modules are again supplied with voltage, and the accumulators in the battery modules are charged. The voltage in the circuit branch that can be measured for this purpose can, for example, be a voltage that is measured by way of the battery modules as well as the switch. Alternatively, this voltage or another measured value can also be measured at another point in the circuit branch, or at other points in the power supply system, in order to deduce whether the load voltage would actually be lower than the maximum permissible charging voltage after the switch has been moved into the non-blocking state.

It is preferred if the load voltage is a voltage applied to the battery modules in the circuit branch, or a proportion of the voltage applied to the battery modules in the circuit branch. Accordingly, the load voltage is a voltage to which the battery modules in the circuit are subjected in total. The load voltage is preferably determined with the aid of a voltmeter that measures a voltage across both the battery modules and also the switch in the circuit. A voltage drop across the switch may suitably be taken into account to calculate the actual load voltage across the battery modules. For example, a normal voltage drop across the switch may be subtracted from a measured voltage to obtain the load voltage. In accordance with forms of embodiment of the disclosure, if the voltage drop across the switch is very low, it may be completely ignored when determining the load voltage. In accordance with the disclosure, a voltage measuring device can be connected directly upstream of the battery modules and the switch. However, it is also possible that the power supply system comprises means for measuring a voltage and/or a current elsewhere in the power supply system, and is arranged to derive the load voltage therefrom. It is understood that the load voltage may be a proportion of the voltage applied to the battery modules. Thus, it is irrelevant whether a positive or negative voltage of a certain magnitude is applied to the battery modules.

The switch is preferably designed in such a way that it can block at least a voltage amounting to a difference between an anticipated maximum load voltage in the circuit branch and a minimum maximum permissible charging voltage. The maximum permissible charging voltage can depend on the charging states of the accumulators in the battery modules, that is to say, it can vary during operation, which is why the minimum maximum charging voltage is to be used here. The battery modules can be charged with at most the minimum maximum charging voltage if their module voltages in each case assume a minimum anticipated value. At the minimum maximum charging voltage, there is a maximum possible voltage difference that is to be blocked by the switch. For example, if it is anticipated that a power supply system could be connected to a power supply network with a maximum peak voltage of V₁, but the power supply system is only designed for a minimum maximum permissible charging voltage V₂, which is smaller than V₁, then the switch must be able to block a voltage amounting to V₁-V₂. It is even better if the switch is designed to block at least one anticipated maximum load voltage in the circuit branch. For example, if it is anticipated that the power supply system could be connected to a supply network with a peak voltage V₃, then the switch should preferably be suitable for completely blocking the voltage V₃.

It is advantageous if the power supply system has a voltage measuring device arranged on the input side of the switch for measuring the load voltage. The voltage measuring device is preferably coupled to the control unit described above, and is provided for measuring the peak voltage. The voltage measuring device can be arranged directly in the circuit branch or further upstream of the switch within the power supply system.

In accordance with the disclosure, it is possible that the switch is designed in such a way that it blocks a current flow unidirectionally in the blocking state. Alternatively, the switch can also be designed in such a way that it blocks a current flow bidirectionally in the blocking state. The choice of a suitable switch is determined in particular by the intended charging mode and an anticipated peak voltage that could be applied to the power supply system during a charging process.

It is preferred if the power supply system has a rectifier bridge arranged on the input side of the switch. The rectifier bridge ensures that current can only flow in one direction. Thus, a bidirectional blocking switch can be dispensed with. It is therefore particularly preferred if the power supply system has a unidirectional blocking switch and the rectifier bridge is connected upstream of it on the input side.

In accordance with the disclosure, it is possible that the switch is a transistor. For example, the transistor may be a MOSFET (metal oxide semiconductor field effect transistor) or an IGBT (insulated gate bipolar transistor). Alternatively, the switch may be a TRIAC (bidirectional thyristor triode) or an SCR (controlled silicon rectifier). The switch can also be designed as a switching module of other types.

In accordance with an advantageous embodiment of the disclosure, the switch is arranged in the circuit branch in front of a first battery module of the battery modules or downstream of a last battery module of the battery modules. In particular, the switch is not arranged between two battery modules. In accordance with the disclosure, it is further possible that the circuit branch comprises a resistor connected in parallel with the switch. Otherwise, when the switch is closed, an overvoltage could build up at the switch due to inductive effects. The parallel-connected resistor counteracts this, because a current can flow through it.

It is preferred if the power supply system is set up to check electrical energy provided to the power supply system by the external energy source for the presence of at least one fault characteristic, and to switch off if the fault characteristic is detected. By monitoring suitable parameters, fault conditions can be avoided, for example an unintentional feeding back of electrical energy into a supply network. It is particularly preferred if the fault characteristic is selected from the group comprising a presence of an overcurrent, a presence of an overvoltage, a presence of an undervoltage, an interruption of a connection to an external power source due to a disconnection of a plug, an exceedance of a slew rate of a voltage, an exceedance of a slew rate of a voltage, and an exceedance of, or a falling below, a voltage frequency.

It is advantageous if the bridge circuit is a full bridge. This allows the greatest possible flexibility in connecting the accumulator to the circuit branch. Alternatively, however, it is also possible for the bridge circuit to be a half-bridge or to have a different structure.

In accordance with a preferred form of embodiment of the disclosure, the power supply system comprises a switching means to which the circuit branch is connected, wherein the power supply system further comprises a charging path and a discharging path which are connected to the switching means, and between which the switching means can switch, and wherein the switch is arranged in the charging path. Via the charging path, electrical energy can be supplied to the power supply system in order to charge the accumulators. Via the discharging path, the energy supply system can provide electrical energy to a load. With the aid of the switching means, either the charging path or the discharging path can be electrically conductively connected to the circuit branch in a simple manner. The switching means preferably has one or more relays. Preferably, the rectifier bridge described above can also be arranged in the charging path. Furthermore, it is advantageous if the voltage measuring device described above is arranged in the charging path.

In accordance with the disclosure, it is also possible that the power supply system is set up to de-energise the switch before it is placed in the blocking state by the bridge circuits assuming suitable switching states for this purpose. In this way, an overload of the switch can be avoided if it is to be suddenly placed in the blocking state. In order to ensure that the switch is actually de-energised, a current measuring device can be arranged in the circuit branch in accordance with the disclosure. In accordance with the disclosure, the setting of the switch to the blocking state can be delayed until the switch is actually de-energised. Preferably, the power supply system is arranged to raise continuously a current applied to the switch from a zero level to an operating level during and immediately after setting the switch to a non-blocking state, by the bridge circuits assuming suitable switching states for this purpose. This prevents the current from rising too quickly or dI/dt from becoming too high, which could lead to an overload of the switch. A too high value of dI/dt could also lead to conducted disturbances that could affect a supply network to which the power supply system is connected.

In accordance with another aspect of the disclosure, a method for charging a power supply system with an AC voltage is proposed, wherein the power supply system comprises a multiplicity of battery modules, each battery module comprising a first electrical terminal and a second electrical terminal, by way of which the battery modules are arranged in series in a circuit branch of the power supply system, wherein each battery module further comprises an accumulator which can be connected to the first electrical terminal and the second electrical terminal by way of a bridge circuit of the battery module, and wherein the power supply system temporarily sets a switch arranged in series with the battery modules to a blocking state so that a load voltage in the circuit branch does not exceed a maximum permissible charging voltage. Accordingly, the battery modules are prevented from being subjected to an excessively high voltage.

It is advantageous if, when carrying out the method, a control unit of the power supply system puts the switch into the blocking state as soon as the load voltage exceeds the maximum permissible charging voltage. In accordance with the disclosure, the control unit can monitor the load voltage by means of a voltage measuring device of the power supply system. In accordance with the disclosure, the method can further be carried out in such a way that the control unit shifts the switch from the blocking state to a non-blocking state during the charging process as soon as the circuit branch is subjected to a voltage that is so high that the load voltage, after moving the switch to the non-blocking state, is lower than the maximum permissible charging voltage of the power supply system. If the voltage drops to such an extent that the load voltage would be below the maximum permissible charging voltage after the switch has been moved into the non-blocking state, the accumulators can consequently be charged again.

In accordance with the disclosure, it is possible for the switch to be de-energised before being placed in the blocking state by the bridge circuits, assuming suitable switching states for this purpose. As described above, an overload of the switch can thus be avoided. Furthermore, preferably, a current applied to the switch during and immediately after a shift of the switch into a non-blocking state is continuously raised from a zero level to an operating level by the bridge circuits assuming suitable switching states for this purpose. This is advantageous because it prevents a current in the power supply system from rising too quickly. Otherwise, overload effects and disturbances could occur in a connected supply network.

### BRIEF DESCRIPTION OF THE DRAWINGS

Advantageous variants of the disclosure are illustrated by way of example in the figures. Here:

FIG. 1 shows a schematic representation of an energy supply system in accordance with the disclosure,

FIG. 2 shows a schematic representation of a battery module of the battery arrangement in accordance with FIG. 1,

FIG. 3 shows a schematic representation of a bridge circuit of the battery module in accordance with FIG. 2,

FIG. 4 shows a schematic representation of a unidirectional blocking switch,

FIG. 5 shows a schematic representation of a bidirectional blocking switch,

FIG. 6 shows a diagram of a current and a voltage curve over time when carrying out the method in accordance with the disclosure, and

FIG. 7 shows a schematic representation of a variant of the energy supply system in accordance with the disclosure.

### DETAILED DESCRIPTION OF THE DRAWINGS

FIG. 1 shows a schematic representation of an energy supply system 1 in accordance with the disclosure. A multiplicity of battery modules 2 are arranged in the energy supply system 1. These are connected in series in a circuit branch 9. A first battery module 13 and a last battery module 14 are identified separately here. Each battery module 2 has a first electrical terminal 3 and a second electrical terminal 4, by way of which the respective battery module 2 is connected to the circuit branch 9. A control unit 11 controls the battery modules 2 in a suitable manner during a discharging process so that their voltages produce an approximately sinusoidal AC voltage in total. During a charging process, the control unit 11 controls the battery modules 2 in such a way that the accumulators of the battery modules 2 are always connected with a voltage of a correct polarity, and can thus be charged.

A coil 20, a voltage meter 18 and a current meter 19 are arranged in the circuit branch 9. Furthermore, a switch 10 is arranged in the circuit branch 9, which is connected upstream of the last battery module 14 on the input side. The voltage measuring device 18 is in turn connected upstream of the switch 10 on the input side. The control unit 11 sets the switch 10 to a blocking state as soon as a load voltage determined with the aid of the voltage measuring device 18 exceeds a maximum permissible charging voltage. This prevents the battery modules 2 from being subjected to an impermissibly high voltage that could damage the battery modules 2.

FIG. 2 shows a schematic representation of one of the battery modules 2 of the power supply system in accordance with FIG. 1. The battery module 2 has an accumulator 5, which can be charged and discharged electrically. The battery module 2 further comprises a bridge circuit 6, which is connected to the first electrical terminal 3 and the second electrical terminal 4 of the battery module 2. The bridge circuit 6 can assume different switching states. For example, it can change a polarity with which the first electrical terminal 3 and the second electrical terminal 4 are connected to an inner branch 21 of the battery module 2. Furthermore, the bridge circuit 6 can bridge the inner branch 21. By suitably changing the switching states, a multiplicity of battery modules 2 arranged in series can thus provide an AC voltage. Furthermore, it is possible to charge the battery 5. The battery module 2 also has an insulation device 22. This galvanically isolates an interior of the battery module 2 from a control terminal 23 of the battery module 2 and contains an optocoupler for this purpose.

A bridge control 24 receives a signal generated by the control device indicating a desired switching state. This signal is fed to the bridge control 24, starting from the control terminal 23 by way of the isolation device 22. Depending on the signal, the bridge control 24 controls the bridge circuit 6 in such a way that the switching state specified by the signal is established. A capacitor 25 is arranged in the inner branch 21. A disconnecting device 26 in the inner branch 21 allows the accumulator 5 to be disconnected from the inner branch 21 if necessary. Furthermore, a fuse 27 is arranged in the inner branch 21, which causes a separation of the accumulator 5 from the inner branch 21 in the event of an overcurrent.

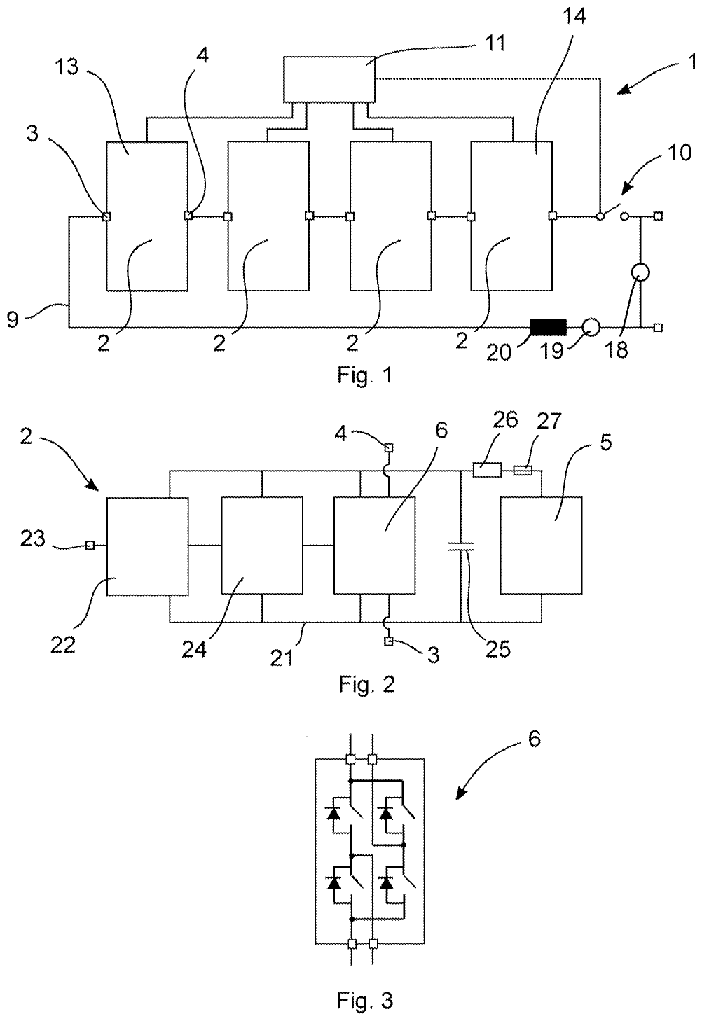

FIG. 3 shows a schematic representation of the bridge circuit 6 of the battery module in accordance with FIG. 2. This is a full bridge, so a wide variety of switching states are possible. In accordance with other forms of embodiment of the disclosure, however, a half-bridge can also be used, for example.

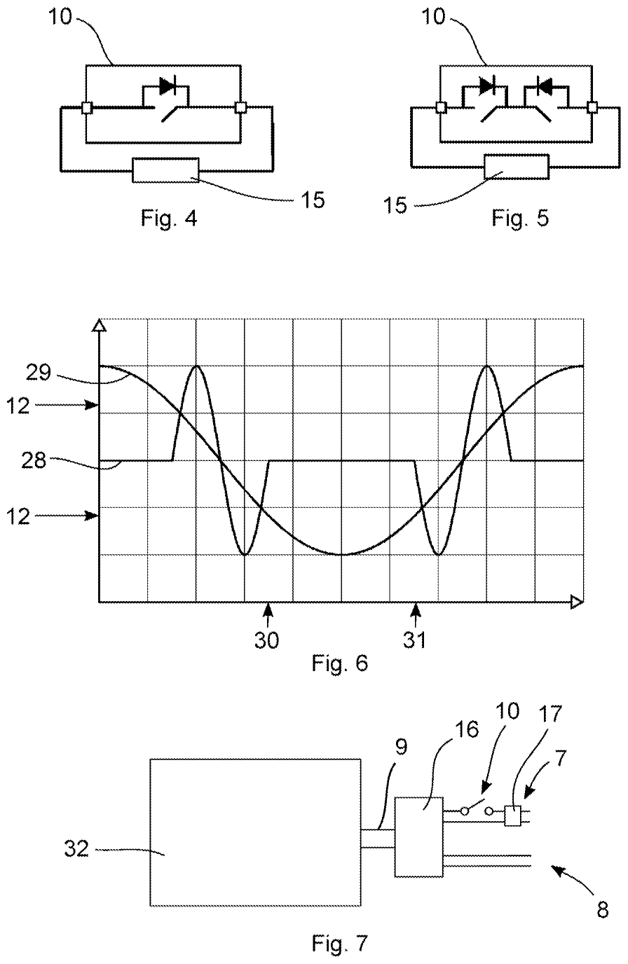

FIG. 4 shows a schematic representation of a unidirectional blocking switch 10, which in a blocking state continues to allow current flow in one direction. The switch 10 is formed by a MOSFET which has a diode-type behaviour. A resistor 15 is connected in parallel with the switch 10. The resistor 15 is used to prevent an overvoltage on the switch 10 if the switch 10 is switched from a non-blocking state into a blocking state.

FIG. 5 shows a schematic representation of a bidirectional blocking switch 10, which in a blocking state does not allow current flow in any direction. The switch 10 is formed by two MOSFETs arranged in series, but with different drain and source orientations. A resistor 15 is connected in parallel with the switch 10. The resistor 15 serves to prevent an overvoltage on the switch 10 if the switch 10 is switched from a non-blocking state into a blocking state.

FIG. 6 shows a diagram of a current and a voltage curve over time when carrying out the method in accordance with the disclosure. A current curve 28 and a voltage curve 29 show a profile of the current and voltage over time. A voltage underlying the voltage curve 29 is measured by a voltage measuring device in the circuit, which measures a voltage across the switch as well as the battery modules. This voltage approximates the load voltage when the power system switch is in a non-blocking state. If the switch is in a blocking state, the load voltage ideally has a value of 0 V and the voltage curve 29 only represents the voltage value that the load voltage would assume if the switch were immediately placed in the non-blocking state.

The power supply system is connected to a supply network which supplies the power supply system with a sinusoidal AC voltage in accordance with the voltage curve 29. The current curve 28 describes a current in the circuit branch of the power supply system. However, the voltage curve 29 has peak values that exceed a maximum permissible charging voltage 12 that may be applied to the battery modules of the power supply system. The power supply system therefore ensures that the load voltage is limited. For this purpose, the load voltage in the circuit branch is continuously measured. At a first point in time 30, the load voltage exceeds the maximum permissible charging voltage 12. The switch of the power supply system is moved into a blocking state and a current flow in accordance with the current curve 28 ceases. Overloading of the battery modules is avoided. At a second point in time, however, the voltage curve 29 falls below the maximum permissible charging voltage, so that the switch is moved into a non-blocking state. A current can now flow again and the battery modules of the power supply system can continue to be charged. The process described is repeated cyclically.

FIG. 7 shows a schematic representation of a variant of the power supply system 1 in accordance with the disclosure. Components arranged in a circuit branch 9 of the power supply system 1 are shown in an abstracted manner by a module block 32. The structure contained therein is similar to that shown in FIG. 1, but the switch 10 of the power supply system 1 is not included in the module block 32. The power supply system 1 has a switching means 16 to which the circuit branch 9 is connected. The power supply system 1 further comprises a charging path 7 and a discharging path 8, which are connected to the switching means 16, and between which the switching means 16 can switch. The switching means 16 has a multiplicity of relays, by means of which it can switch between the charging path 7 and the discharging path 8. The switch 10 is arranged in the charging path 7. This design allows battery modules of the power supply system optionally to be charged by way of the charging path 7, or discharged by way of the discharging path 8, so that electrical energy can be provided to a connected load. A rectifier bridge 17 is also arranged in the charging path 7, which ensures that a current can only flow into the switch 10 in one direction.

1. A power supply system comprising a multiplicity of battery modules, wherein each battery module has a first electrical terminal and a second electrical terminal, by way of which the battery modules are arranged in series in a circuit branch of the power supply system, wherein
each battery module further comprises an accumulator connected to the first electrical terminal and the second electrical terminal, by way of a bridge circuit of the battery module, wherein
the power supply system has a switch, which is arranged in series with the battery modules, and temporarily moved into a blocking state so that, during a charging process of the power supply system with an AC voltage from an external energy source, a load voltage in the circuit branch does not exceed a maximum permissible charging voltage.

2. The power supply system according to claim 1, wherein the power supply system has a control unit configured to put the switch into the blocking state as soon as the load voltage exceeds the maximum permissible charging voltage.

3. The power supply system according to claim 2, wherein the control unit is set up to move the switch from the blocking state to a non-blocking state during the charging process as soon as a voltage is applied to the circuit branch, which is of a level such that the load voltage after moving the switch into the non-blocking state is lower than the maximum permissible charging voltage of the power supply system.

4. The power supply system according to claim 1, wherein the load voltage is a voltage applied to the battery modules in the circuit branch, or a proportion of the voltage applied to the battery modules in the circuit branch.

5. The power supply system according to claim 4, wherein the switch is designed to block at least a voltage equal to a difference between an anticipated maximum voltage in the circuit branch and a minimum maximum permissible charging voltage.

6. The power supply system according to claim 4, wherein the switch is designed to block at least one anticipated maximum load voltage in the circuit branch.

7. The power supply system according to claim 1, wherein the power supply system has a voltage measuring device arranged on the input side of the switch for measuring the load voltage.

8. The power supply system according to claim 1, wherein the switch is designed to block a current flow unidirectionally in the blocking state.

9. The power supply system according to claim 1, wherein the switch is designed to block a current flow bidirectionally in the blocking state.

10. The power supply system according to claim 1, wherein the power supply system has a rectifier bridge arranged on the input side of the switch.

11. The power supply system according to claim 1, wherein, the switch is a transistor.

12. The power supply system according to claim 1, wherein the switch is a TRIAC.

13. The power supply system according to claim 1, wherein, the switch is an SCR.

14. The power supply system according to claim 1, wherein the switch is arranged in the circuit branch in front of a first battery module of the battery modules, or behind a last battery module of the battery modules.

15. The power supply system according to claim 1, wherein, the circuit branch has a resistor, which is connected in parallel with the switch.

16. The power supply system according to claim 1, wherein the power supply system is arranged to check electrical power provided by the external power source to the power supply system for the presence of at least one fault characteristic, and to switch off upon detection of the fault characteristic.

17. The power supply system according to claim 16, wherein the fault characteristic is selected from the group consisting of: a presence of an overcurrent, a presence of an overvoltage, a presence of an undervoltage, an interruption of a connection to an external power source due to a disconnection of a plug, an exceedance of a slew rate of a voltage, an exceedance of a fall rate of a voltage, and an exceedance of, or a falling below, a voltage frequency.

18. The power supply system according to claim 1, wherein, the bridge circuit is a full bridge.

19. The power supply system according to claim 1, wherein, the power supply system has a switching means to which the circuit branch is connected, wherein
the power supply system furthermore comprises a charging path and a discharging path, which are connected to the switching means, and between which the switching means is configured to switch, and wherein the switch is arranged in the charging path.

20. The power supply system according to claim 1, wherein the power supply system is set up to deenergize the switch before it is placed in the blocking state by the bridge circuits assuming switching states suitable for this purpose.

21. The power supply system according to claim 1, wherein the power supply system is adapted to raise continuously a current applied to the switch from a zero level to an operating level during, and immediately after placing the switch in a non-blocking state by the bridge circuits assuming switching states suitable for this purpose.

22. A method for charging a power supply system with an AC voltage, wherein
the power supply system comprises a multiplicity of battery modules, wherein
each battery module has a first electrical terminal and a second electrical terminal, by way of which the battery modules are arranged in series in a circuit branch of the power supply system, wherein
each battery module further comprises an accumulator configured to be connected to the first electrical terminal and the second electrical terminal by way of a bridge circuit of the battery module, and wherein the power supply system temporarily puts a switch arranged in series with the battery modules into a blocking state during the charging process, so that a load voltage in the circuit branch does not exceed a maximum permissible charging voltage.

23. The method according to claim 22, whereby a control unit of the power supply system sets the switch to the blocking state as soon as the load voltage exceeds the maximum permissible charging voltage.

24. The method according to claim 23, whereby the control unit shifts the switch from the blocking state to a non-blocking state during the charging process as soon as a voltage is applied to the circuit branch which is so high that the load voltage after moving the switch to the non-blocking state is lower than the maximum permissible charging voltage of the power supply system.

25. The method according to claim 22, whereby the switch is deenergized before being placed in the blocking state by the bridge circuits assuming switching states suitable for this purpose.

26. The method according to claim 22, whereby a current applied to the switch during and immediately after a movement of the switch into a non-blocking state is continuously raised from a zero level to an operating level by the bridge circuits assuming switching states suitable for this purpose.
